(19) United States
(12) Patent Application Publication
(10) Pub. No.: US 2026/0171532 A1
(43) Pub. Date: Jun. 18, 2026

(54) THERMAL BATTERY CONTROL SYSTEM AND METHOD

(71) Applicant: Intellihot, Inc., Galesburg, IL (US)

(72) Inventors: Sridhar Deivasigamani, Mundelein, IL (US); Sivaprasad Akasam, Round Rock, TX (US)

(21) Appl. No.: 18/984,960

(22) Filed: Dec. 17, 2024

Related U.S. Application Data
(63) Continuation-in-part of application No. 18/081,654, filed on Dec. 14, 2022, now Pat. No. 12,352,506.

(51) Int. Cl. H01M 10/633; H01M 10/615; H01M 10/6552; H01M 10/6567; H01M 10/6569; H02J 7/00

(52) U.S. Cl. CPC H01M 10/633; H01M 10/615; H01M 10/6552; H01M 10/6567; H01M 10/6569; H02J 7/82

(57) ABSTRACT

A method for controlling a heating system to meet a heating demand, the heating system including more than one thermal battery, the method including comparing a state of charge (SOC) of one of the more than one thermal battery to a low thermal storage threshold, wherein if the SOC is lower than the low thermal storage threshold and the more than one thermal battery is more than one thermal battery, disposing the control valve of the one of the more than one thermal battery in a closed state; and comparing the SOC of one of the more than one thermal battery to a high thermal storage threshold, wherein if the SOC is greater than the high thermal storage threshold, disposing the control valve of the one of the more than one thermal battery in an open state.

### PRIORITY CLAIM AND RELATED APPLICATIONS

This continuation-in-part application claims the benefit of priority from non-provisional application U.S. Ser. No. 18/081,654 filed Dec. 14, 2022. Said application is incorporated by reference in its entirety.

### BACKGROUND OF THE INVENTION

### 1. The Field of the Invention

The present invention relates to an electric tankless heating system. More specifically, the present invention is directed to an electric tankless heating system composed of subsystems interconnected using a simplified fluid network.

### 2. Background Art

In water heating systems, the potential for Legionella is more pronounced in a tank system or a large fluid conductor, e.g., in a tank water heater, etc., due to the low velocity of the contents of the tank water heater and the contents that are disposed in a suitable temperature range for Legionella proliferation. Although one or more temperature sensors may be used for providing feedback to the heating of the contents of the tank water heater to achieve a setpoint temperature, the effect of stratification can cause layers of fluid to have different temperatures. Therefore, although portions of the contents of a water heater may be disposed at a setpoint temperature that is unfavorable for Legionella proliferation, there potentially exists other portions that may be disposed at temperatures suitable for Legionella proliferation. Further, in a tank heating system, potable water is drawn from a large reservoir of heated water to meet a hot water demand, increasing the risk of Legionella proliferation as the opportunity for a tank heating system to harbor Legionella is significantly higher than a tankless heating system where hot potable water is prepared just-in-time.

Scaling and corrosion are longstanding problems encountered in the water heating industry which limit the life span of equipment. Although many corrosion and scale inhibitors are known and used in high temperature applications, many of these systems have limitations and do not provide the type of protection to allow significant extension of equipment life span. Conventional water heaters cannot store potable water at a very high temp due to the potential for scaling and hence corrosion.

Solar heating systems or heaters have become increasingly popular solutions either as a supplemental heating system or as a sole heating system whether or not municipal electricity is available. Where thermal batteries and swing tanks are involved and are made to function in conjunction with solar heaters, the overall heating solutions are often complicated to set up, involving set up procedures which are not only challenging for trained professionals to set up but also difficult for a user to detect a problem or the root cause of a problem if they malfunction during use. Further, these systems are often not easily scalable as there is very little reuse in the way of common subsystems being sourced as modules that can be added or removed.

Thus, there is a need in the heating art for a system that is scalable and a system having subsystems that contribute to meet the overall heating demand in an efficient manner, i.e., according to the respective conditions of the subsystems at the time hot water is demanded. There exists a need for isolating thermal batteries not required to be involved in a thermal charging or discharging action from the rest of the heating system. There is also a need in the heating art for a system that can be installed and set up on site without significant knowledge on the part of the technician. This ensures the system is set up correctly on site without having to set up at factory, prior to delivery, which can incur significant additional shipping costs due to additional shipping weights caused mainly by working fluids in the system.

### SUMMARY OF THE INVENTION

In accordance with the present invention, there is provided a method for controlling a heating system to meet a heating demand, the heating system including more than one thermal battery, each of the more than one thermal battery includes a storage container for holding a thermal energy storage material, a heat exchange tubing having a first end and a second end within which a fluid is configured to be disposed from the first end to the second end to be heated by the thermal energy storage material, a control valve interposed on the first end of the heat exchange tubing and a controller functionally connected to the control valve, the method including, using the controller for:
(a) comparing a state of charge (SOC) of one of the more than one thermal battery to a low thermal storage threshold, wherein if the SOC is lower than the low thermal storage threshold, disposing the control valve of the one of the more than one thermal battery in a closed state; and
(b) comparing the SOC of one of the more than one thermal battery to a high thermal storage threshold, wherein if the SOC is greater than the high thermal storage threshold, disposing the control valve of the one of the more than one thermal battery in an open state.

In one embodiment, the low thermal storage threshold is about 25%. In one embodiment, the high thermal storage threshold is about 35%.

In accordance with the present invention, there is further provided a method for controlling a heating system to meet a heating demand, the heating system including more than one thermal battery, each of the more than one thermal battery includes a cumulative measure of usage, a storage container for holding a thermal energy storage material, a heat exchange tubing having a first end and a second end within which a fluid is configured to be disposed from the first end to the second end to be heated by the thermal energy storage material, a control valve interposed on the first end of the heat exchange tubing and a controller functionally connected to the control valve, the method including, using the controller for comparing a number of units of the more than one thermal battery required to meet the heating demand to a number of units of the more than one thermal battery having the control valve disposed in an open state, wherein if the number of units of the more than one thermal battery required to meet the heating demand is lower than the number of units of the more than one thermal battery having the control valve disposed in an open state, disposing the control valve of the thermal battery having a highest cumulative measure of usage of the more than one thermal battery having the control valve disposed in an open state, in a closed state; and if the number of units of the more than one thermal battery required to meet the heating demand is higher than the number of units of the more than one thermal battery having the control valve disposed in an open state, disposing the control valve of the thermal battery having a lowest cumulative measure of usage of the more than one thermal battery having the control valve disposed in a closed state, in an open state.

In one embodiment, the control valve includes a first valve and a second valve, the first valve is a fail-close valve and the second valve is a proportional valve. In one embodiment, the number of units of the more than one thermal battery required to meet the heating demand is determined by dividing the heating demand by the maximum thermal power afforded by one of the more than one thermal battery.

An object of the present invention is to provide a method for managing the use of an optimal number of thermal batteries to meet hot water demands in a cost-efficient and timely manner.

Another object of the present invention is to provide a method for ensuring that a discharging thermal battery retains sufficient thermal energy to heat domestic water flows and supply hot water at the desired temperature.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting an electric tankless heating system;

FIG. 2 is a diagram depicting a heat pump suitable to provide heat source to the heating system shown in FIG. 1;

FIG. 3 is a diagram depicting a heating system suitable to provide heat source to the heating system shown in FIG. 1;

FIG. 4 is a diagram depicting a thermal battery functionally connected to a controller;

FIG. 5 is a state diagram of a control scheme of a thermal battery of the heating system shown in FIG. 1;

FIG. 6 is a diagram depicting an operational scenario of the heating system shown in FIG. 1, based on the control scheme disclosed in FIG. 4 where the demand of hot water is met by only one thermal battery;

FIG. 7 is a diagram depicting an operational scenario of the heating system shown in FIG. 1, based on the control scheme disclosed in FIG. 4 where the demand of hot water is met by two thermal batteries;

FIG. 8 is a diagram depicting an operational scenario of the heating system shown in FIG. 1, based on the control scheme disclosed in FIG. 4 where the demand of hot water is met by all three thermal batteries; and

FIG. 9 is a diagram depicting an operational scenario of the heating system shown in FIG. 1, based on the control scheme disclosed in FIG. 4 where the demand of hot water is met by two thermal batteries.

### PARTS LIST

2—heating system
4—thermal battery
5—storage container
6—heated fluid inlet
8—spent fluid outlet
10—water inlet
12—water outlet
14—isolation valve
16—isolation valve
18—inlet valve
20—coil isolation valve
22—bypass valve
24—pump
26—pump
28—fill valve
30—heat transfer fluid conductor, e.g., coil
32—opening, e.g., vent
34—glycol concentration sensor
36—level sensor
38—float switch
40—outlet fluid conductor
42—inlet fluid conductor
44—solar heater
46—pump
48—working fluid, e.g., glycol
50—inlet point
52—outlet point
54—resistive heater
56—bypass conductor
58—heat exchanger, e.g., gas cooler
60—heat source, e.g., heat pump
62—heat exchanger, e.g., gas cooler
64—heat source, e.g., heat pump
66—heat pump
68—check valve
70—fluid conductor
72—fluid conductor
74—fluid conductor
76—fluid conductor
78—controller
80—power-on self-test (POST)
82—thermal battery in use state
84—thermal battery idle state
86—state in which thermal battery is inoperable
88—thermal battery unavailable state
90—thermal battery communication failure state
92—connection to communication bus shared by thermal batteries and other controllers
94—computation to determine whether state transition is warranted

### PARTICULAR ADVANTAGES OF THE INVENTION

Installation and start-up of prior art solar-integrated heating systems require high levels of technical knowledge. In one embodiment of the present heating system, interconnections between components have been simplified, making the task of putting together the heating system a task manageable by personnel trained only for conventional heating systems and a task which does not require specific training unique to the heating systems with solar heater integration. Prior art heating systems with solar heater integration require complicated plumbing as one or more swing tanks are used. If not installed and/or configured properly, prior art heating systems would not function correctly and may even be a safety hazard.

Further, the present heating system operates according to the concept of providing heating of water just in time to be used, therefore without a need to store a large amount of hot water before it is used. In prior art heating systems with thermal batteries incorporating swing tanks for holding domestic hot water, a significant volume of domestic hot water intended for consumption is stored within the thermal batteries, creating an environment conducive to Legionella growth. By minimizing the storage of large volumes of domestic hot water, the risk of a Legionella outbreak is substantially reduced.

Since the thermal batteries are connected in parallel, the contribution of each thermal battery to heating the water supply passing through it can be accurately estimated. This enables the system to maintain an optimal number of thermal batteries actively participating in the heating process.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

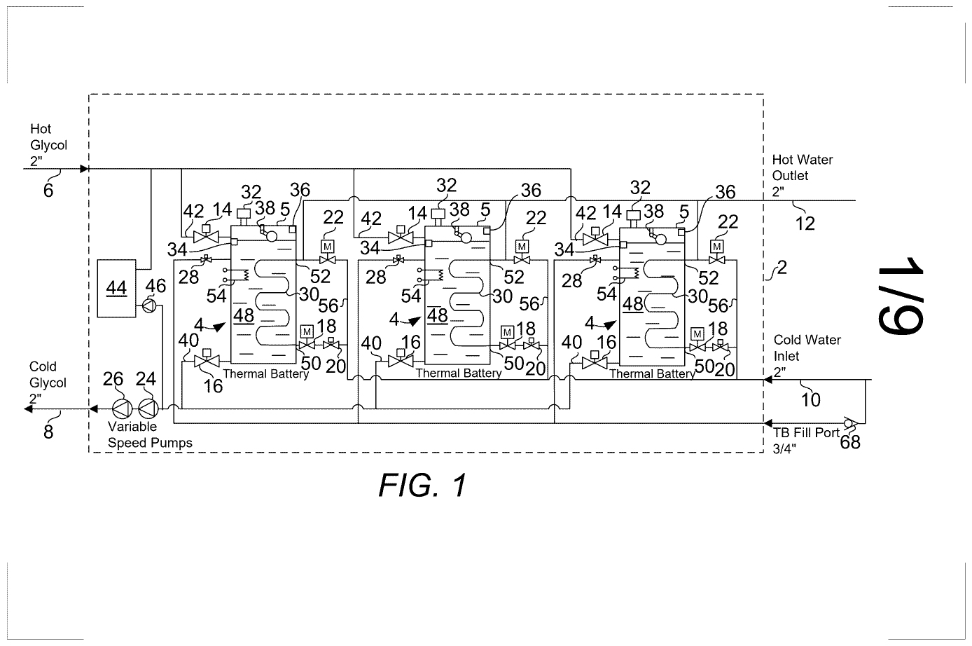

FIG. 1 is a diagram depicting an electric tankless heating system 2. Although three thermal batteries 4 are shown, the heating system needs only at least one thermal battery to function. To add thermal storage capacity, more thermal batteries of the type disclosed elsewhere can be added, making the storage capacity and hence the heating capacity of potable water scalable. Each thermal battery 4 includes a storage container 5 for holding a fluid 48, an outlet fluid conductor 40 through which the fluid 48 exits the storage container 5, an inlet fluid conductor 42 through which the fluid enters the storage container 5, a first valve 16 interposed in the outlet fluid conductor 40 and a second valve 14 interposed in the inlet fluid conductor 42. Each thermal battery 4 is configured to be thermally chargeable and dischargeable by controlling the first valve 16 and the second valve 14 to allow a flow of the fluid 48 in concert and to disallow a flow in concert through the conductors on which valves 14, 16 are disposed. In one aspect, the controller 78 is configured to issue a valve closing command or a valve opening command to the valves 14, 16 to drive the valves 14, 16 to their close or open state simultaneously. It shall be noted that for each thermal battery 4, as the flows through the inlet fluid conductor and the outlet fluid conductor are controlled using these two valves 14, 16, each thermal battery 4 can be isolated from the rest of the heating system by or brought back online to contribute to either charging or discharging of the thermal battery 4. The total hot water demand of a location is met by the plurality of thermal batteries 4, with each thermal battery 4 contributing to a portion of the water-heating demand. Collectively, the plurality of thermal batteries 4 fulfills the total demand.

In one embodiment, the storage container is non-pressurized. The storage container 5 includes an opening 32 and is configured to hold a first fluid 48 therein. The opening 32 is configured to expose the first fluid 48 to atmospheric pressure. As such, the storage container 5 is not a pressurized vessel and not required to withstand pressure exerted by pressurized contents and therefore can be made to meet minimal requirements of a storage container, resulting in an inexpensive, easy-to-fabricate and easy-to-maintain storage container. Contrast this to conventional thermal batteries where pressurized tanks are used. Each present container does not need to be built to withstand a pressure higher than the ambient pressure and therefore no special materials and container wall thicknesses that are required to provide containers capable of withstanding pressure significantly higher than the ambient pressure. Each present container is therefore ubiquitous, has low procurement and maintenance costs. The thermal batteries 4 are connected in parallel to be filled during installation with the filling of each thermal battery 4 controlled by a fill valve 28. The fill valve-equipped lines are further connected to a check valve 68 which allows flow into the storage container while the fill valve/s are open while preventing exit of the fluid 48 into the cold water inlet 10. As the check valve 68 is connected to a potable water source, this eliminates the possibility that the potable water can be contaminated by a back flow of the fluid or working fluid, e.g., glycol into the potable water flow. In the embodiment shown, the heating system 2 further includes a heat transfer fluid conductor 30 disposed through the fluid 48 from an inlet point 50 at the storage container 5 to an outlet point 52 at the storage container 5, the heat transfer fluid conductor 30 is configured to receive a second fluid, e.g., potable water, at a first temperature at the inlet point 50 and to supply the second fluid at a second temperature higher than the first temperature. The rate at which heat is lost to the second fluid in the heat transfer fluid conductor 30 represents essentially the discharging rate of the thermal battery 4. In the embodiment shown, the heating system 2 further includes two pumps 24, 26 to draw the fluid through the outlet fluid conductor 40 out of storage containers 5 having their respective valves 16 open. In one embodiment, at least one of the pumps 24, 26 is a variable speed pump. In controlling the flow through the pumps 24, 26, the speed of a pump may be modulated to provide an optimal flowrate of the working fluid 48 to a heat exchanger connected to a heat source before returning to the storage container 5 through the inlet fluid conductor 42. During normal operations, the required flowrate may be met with only one pump turned on. However, in one mode, both are configured to turn on at an appropriate speed to result in the desired combined flowrate. In order to maintain the second fluid temperature at outlet 12, care must be taken to ensure that the rate at which contributing thermal batteries is charged, is sufficient in meeting the thermal discharging rate. In one embodiment, the fluid 48 is glycol. In one embodiment, each thermal battery further includes a glycol concentration sensor 34 configured for detecting the concentration of the fluid 48 to determine the suitability of the fluid to resist freezing. In one embodiment, at least one thermal battery includes a controller and a glycol concentration sensor 36 functionally connected to the controller, the controller is configured to receive data from the glycol concentration sensor 34 and determine the suitability of the fluid to resist freezing based on location data. This is especially important if the heating system 2 and any plumbing connections may be exposed to the outdoor elements in temperate regions. In the embodiment shown, a fluid level sensor 36 is provided to allow the level of the storage container contents to be determined. This allows the exact level of the contents to be determined and the amount of glycol to be replenished in the storage containers 5. The level of the contents of the storage container can also be ascertained using a float switch 38 as the right content level causes the float switch to report a state indicating that the contents are disposed at an appropriate level.

It shall be noted that cold water is received at a cold water inlet 10 with an inlet pipe which connects the cold water inlet to the heat transfer fluid conductor 30. Heated water is supplied at a hot water outlet via an outlet pipe which connects the heat transfer fluid conductor 30 to the hot water outlet 12. The heat transfer fluid conductor 30 is disposed through the fluid, e.g., glycol, from an inlet point 50 at the storage container 5 to an outlet point 52 at the storage container 5, the heat transfer fluid conductor 30, e.g., a coil, is configured to receive a second fluid at an inlet temperature at the inlet point 50 and to supply the second fluid, e.g., potable water, at an outlet temperature at the outlet point 52 that is higher than the inlet temperature.

The fluid 48 held in the storage container is stratified, i.e., the temperature of the fluid 48 near the top of the storage container 5 is disposed at a temperature higher than the first fluid near the bottom of the storage container 5. Therefore, the inlet point 50 is disposed in the fluid 48 at a first temperature and the outlet point is disposed in the fluid 48 at a second temperature where the second temperature is higher than the first temperature. As the first temperature is lower and the thermal energy of the contents in the lower region of the storage container has been largely depleted, this ensures that the fluid drawn by the pumps 24, 26 is devoid of thermal energy and ready to draw thermal energy from a heat source. Even if residual thermal energy remains in the lower region of the storage container, it is readily transferred to the domestic water flow entering at inlet point 50. This ensures that the fluid drawn by pumps 24 and/or 26 is devoid of thermal energy and primed to absorb heat from the heat source.

For each thermal battery 4, the heating system 2 further includes a bypass conductor 56 connecting an inlet and an outlet of the heat transfer fluid conductor 30. A valve 22 is interposed in the bypass conductor 56 to control the magnitude of a bypass flow that is allowed to occur through the bypass conductor 56. The bypass flow merges with the heated flow after passing through valves 18 and 20 and exiting fluid conductor 30, alleviating pressure drop concerns caused by the significant pressure losses associated with the lengths of the fluid conductors and the valves, such as valves 18 and 20, in the heating system. An inlet valve 18, a proportional valve, is disposed at the inlet of the heat transfer fluid conductor 30 to control the magnitude of a flow through the heat transfer fluid conductor 30. A coil isolation valve 20 is connected to the inlet point 50, wherein the coil isolation valve 20 is configured for selectively allowing a flow of the second fluid. The coil isolation valve 20 is an on-off valve and serves as a fail-safe mechanism for an inlet valve 8 which fails as the coil isolation valve 20 is a spring-returned valve configured to close automatically should the inlet valve 18, e.g., a proportional valve fails. This way, a failed inlet valve 8 would not inadvertently cause a second fluid flow to be heated indefinitely in the thermal battery 4 to cause a scalding hot output at the outlet 12. Once the coil isolation valve 20 is closed, an incoming flow through the cold water inlet 10 will be diverted to the bypass conductor 56. A user of the demand will experience unheated water but will avoid potentially scalding hot water due to the failed inlet valve 18. The isolation valve 20 is useful for preventing the thermal effects of recirculation flow through conductor 30 from impacting a thermal battery when discharging is not desired. This may occur, for example, if the thermal battery is faulty and unable to function as a thermal storage device, if the state of charge (SOC) of the thermal energy is low, e.g., below about 25% SOC, or if maintaining the stratification of the contents or thermal energy storage within the thermal battery is necessary.

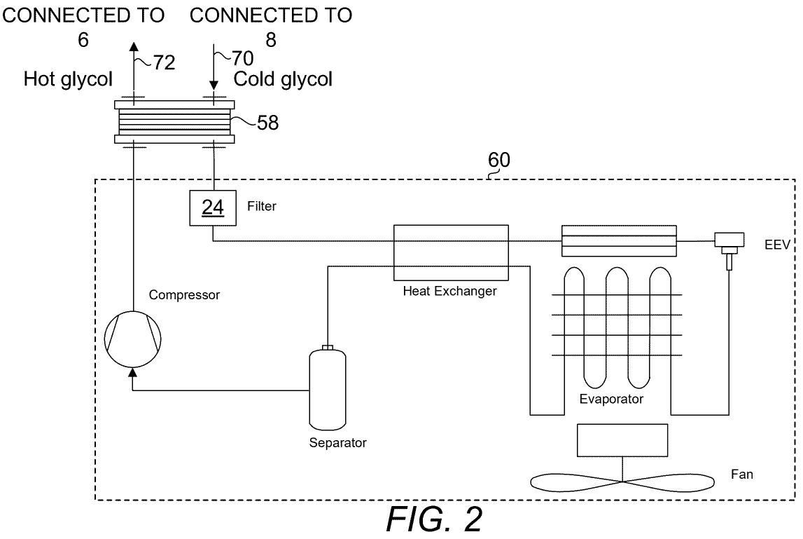

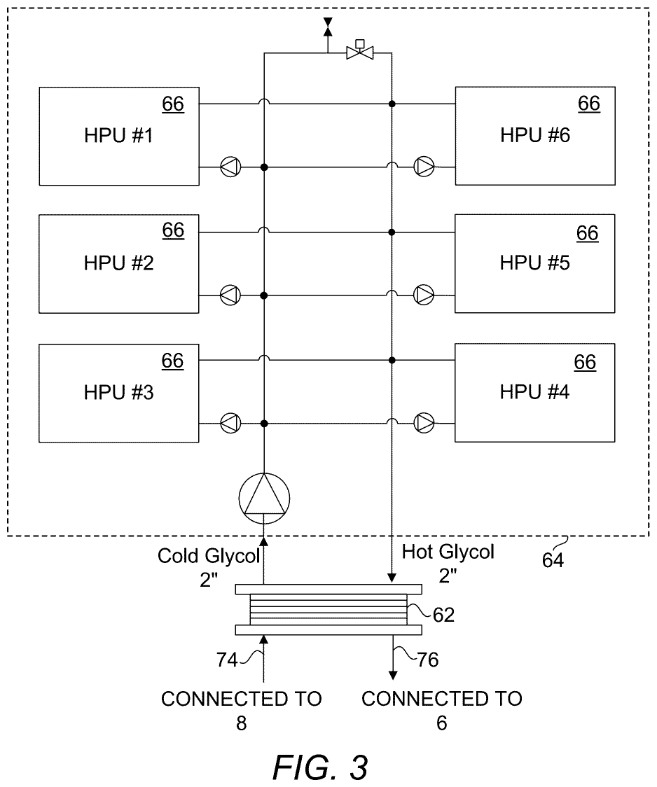

FIG. 2 is a diagram depicting a heat pump 60 suitable to provide heat source to the heating system 2 shown in FIG. 1. The spent fluid outlet 8 is connected to fluid conductor 70. The heated fluid inlet 6 is connected to fluid conductor 72. The heating system 2 shown in FIG. 1 is preferably installed in a temperature-controlled indoor environment to help preserve heat energy stored in the thermal batteries. The heating system 60 shown in FIG. 2 is preferably installed in an outdoor environment where there are no dedicated efforts necessary to ensure that the heat pump 60 is capable of causing air exchanges with the outdoor environment to harness heat energy from the outdoor environment. The heating system 2 shown in FIG. 1 need not be configured to be thermally connected only to the heat pump 60 shown in FIG. 2. As another example, the heating system 2 shown in FIG. 1 can be used in conjunction with a heating system including multiple outdoor heat pumps 66 configured to work together as a unit 64 as shown in FIG. 3. The spent fluid outlet 8 is connected to fluid conductor 74, the heated fluid inlet 6 is connected to fluid conductor 76 and both are connected to a heat exchanger 62 interfaced with heating system 2. Again, the heating system shown in FIG. 1 is preferably installed in a temperature-controlled indoor environment to help preserve heat energy stored in the thermal batteries. Again, the heating system 64 shown in FIG. 3 is preferably installed in an outdoor environment where there are no dedicated efforts necessary to ensure that the heat pumps are capable of causing air exchanges with the outdoor environment to harness heat energy from the outdoor environment. Referring back to FIG. 1, the spent fluid outlet 8 and the heated fluid inlet 6 can also be connected to a solar heater 44 that can assist in thermal charging the contents of the storage container 5 with the aid of a pump 46. Yet further, a resistive heater 54 may also serve as a heat source either to be the sole heat source if other heat sources are not available or a supplemental heat source to add thermal energy to the contents of the storage container 5.

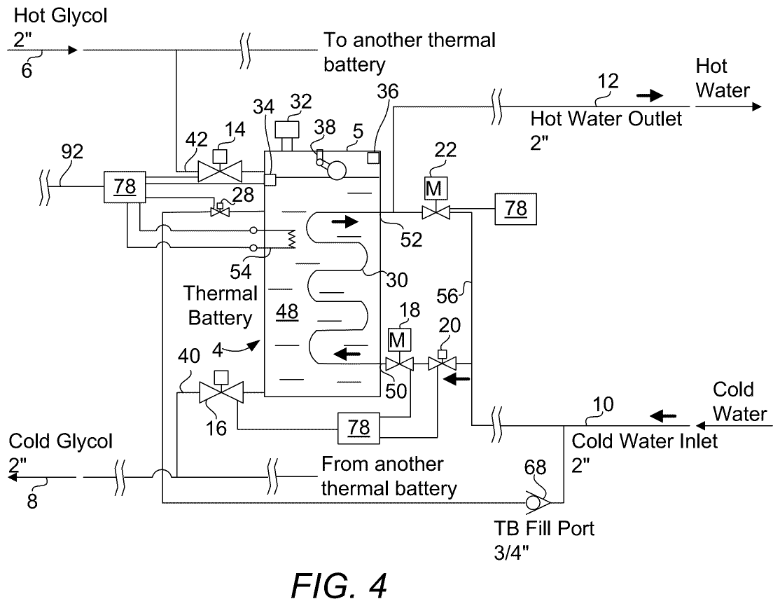

FIG. 4 illustrates a thermal battery 4 functionally connected to a controller 78. Notably, only one thermal battery 4 is shown connected to the controller 78. In a distributed control environment, the controller 78 manages only the thermal battery 4 it is associated with. However, in a centralized control environment, the controller 78 may be connected to a communication bus, as represented by the connection labeled as part 92. The selection of which thermal battery or batteries to charge or discharge is determined by optimizing the coefficient of performance (COP) of the heating system. In one embodiment, the controller 78 computes operational decisions and/or utilizes shared data from other controllers in the heating system to control devices associated with a thermal battery, such as valves 18 and 20, sensors, and other components. In a multi-thermal battery system, decisions regarding charging or discharging a thermal battery may be made by the controller 78 or based on shared data from other controllers. In one embodiment, the heating system 2 is controlled by a master controller. In this centralized control scheme, all operational decisions for devices within the heating system 2 are made and communicated by a central controller 78. In another embodiment, the heating system 2 operates with a distributed control scheme, where each thermal battery 4 is managed by its own dedicated controller 78.

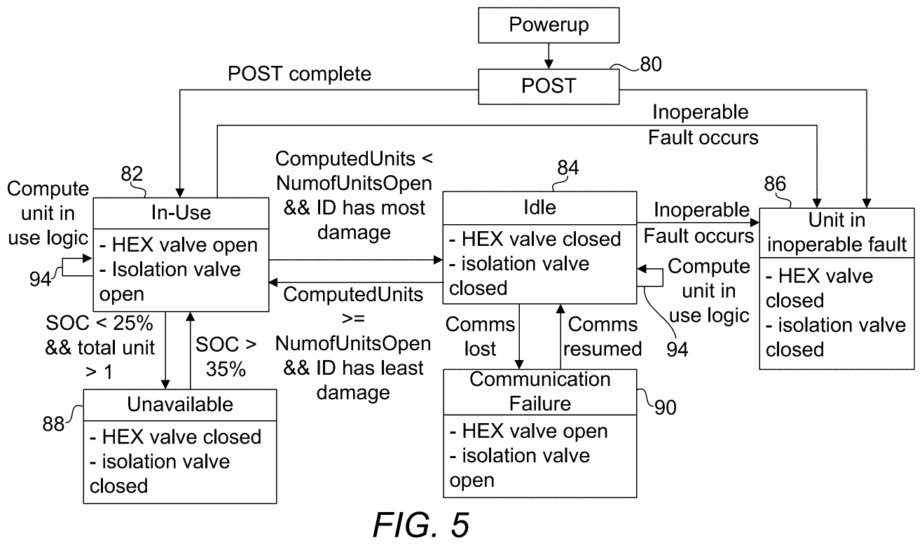

FIG. 5 presents a state diagram of the control scheme for a thermal battery 4 within the heating system 2, as depicted in FIG. 1. Since each thermal battery 4 can be isolated from the others and the thermal batteries 4 are connected in parallel, the discharging operations of the heating system 2 can be carried out using individual thermal batteries 4. Regardless of the control scheme employed, for a heating system 2 with multiple thermal batteries where the services of each battery can be isolated, it is advantageous to optimize the heating process. This ensures hot water is supplied at minimal cost while maintaining maximum availability to meet demand.

In a heating system with a single thermal battery, water heating occurs solely through the heat exchanger or heat transfer fluid conductor associated with that thermal battery. As a result, the thermal battery must maintain a sufficient state of charge (SOC) to meet the hot water demand. However, in a system configured with multiple thermal batteries, when the demand can be met without utilizing all the thermal batteries, one or more batteries 4 can be isolated. This allows the responsibility for heating incoming cold water to rest only on the thermal batteries that remain connected to their respective heat transfer fluid conductors 30.

Upon the initiation of a power-up of the heating system, functionally connected to the controller implementing the present control scheme, a power-on self-test (POST) 80 of the heating system is performed. During this test, devices such as valves 18, 20, and 22, and sensors 34, 36, and 38, are verified to be in working order by checking that their readings fall within valid ranges, and that the communication between the controller, which is functionally coupled with the heat pump that charges the thermal batteries 4, is functional. Sensors are also checked to ensure they are not shorted to ground or experiencing open circuit faults.

Upon power-up, each thermal battery is assigned a state by the controller 78, such as the “in use” state 82, the “idle” state 84, the “inoperable fault” state 86, the “unavailable” state 88, or the “communication failure” state 90, which best reflects its condition. If a thermal battery 4 was previously in the “inoperable fault” state 86 before shutdown and subsequent power-up, it will be powered up to this state. This state can be immediately assigned if it has been cached, for instance, by a controller in persistent memory during shutdown. The “inoperable fault” state indicates a thermal battery that has experienced debilitating faults, such as a leakage detected by a leak sensor or a critically low level of the thermal battery's storage medium, rendering it inoperable. Any resolution of such a condition must be accompanied by the clearance of this state or the reassignment of the thermal battery to a different state, such as the “in use” state 82, the “idle” state 84, or the “unavailable” state 88.

Upon completing POST 80, if the persistent memory does not indicate an inoperable fault prior to shutdown, the thermal battery 4 is automatically assigned the “in use” state 82, and valves 18 and 20 are commanded to the open position. While in this state, periodic computations 94 are performed to evaluate whether the thermal battery should remain in its current state. These computations can include factors such as the SOC of the thermal battery, the number of thermal batteries 4 required to meet the hot water demand, and the cumulative “damage” incurred by the thermal battery, etc.

The SOC of a thermal battery is expressed as the percentage of thermal energy, measured, e.g., in Joules or BTU, stored in the thermal battery relative to its maximum thermal energy storage capacity. Each thermal battery can produce a certain amount of heating power depending on its SOC. The number of thermal batteries required to meet the hot water demand is calculated as the total thermal power required, divided by the maximum thermal power provided by a single thermal battery, with the quotient rounded up. Often, the total hot water demand is an aggregate of the demands from various points of use, e.g., showers, sinks, etc., in establishments, such as hotels with numerous guest rooms.

If the total demand decreases, as determined from periodic computations 94, to a level requiring the participation of fewer thermal batteries, the thermal battery with the highest damage value will transition to the “idle” state 84. Every use of the heating system contributes to the cumulative wear and tear or “damage” of a thermal battery. For simplicity, this “damage” refers to the cumulative measure of usage, which may include the number of heating cycles of the resistive heater or heating element 54, the duration of operation of the resistive heater or heating element 54, the total thermal energy transferred by the working fluid or contents of a thermal battery, the amount of working fluid or contents of a thermal battery cycled through the thermal battery, the duration valves 18 and 20 remain open, the amount of water delivered or glycol-water mixture cycled through a thermal battery, the amount of heat transfer through coil 30. As long as the same metric is used consistently for all thermal batteries, this “damage” value is used to determine which thermal battery transitions to the “idle” state 84. A thermal battery 4 will transition from the “in use” state 82 to the “idle” state 84 if the number of thermal batteries required to meet the demand is fewer than the number of thermal batteries currently active, i.e., with valves 18 and 20 open and if the thermal battery has a higher damage value compared to others in the heating system. A thermal battery's damage value can be communicated to other thermal batteries via a shared communication bus, by embedding the damage value in the identification number of a message transmitted through the shared communication bus. To transition back to the “in use” state 82 from the “idle” state 84, the following conditions must be met. As a hot water demand increases, requiring more thermal batteries than are currently active, as determined by periodic computations 94, if multiple thermal batteries are disposed in the “idle” state 84, the thermal battery with the lowest damage value will be configured to transition to the “in use” state 82. If a thermal battery transitioning to the “in use” state 82 has insufficient SOC, e.g., below about 25%, it will instead transition immediately to the “unavailable” state 88. While in this state, the thermal battery cannot participate in heating but remains ready to resume when its SOC exceeds about 35%. In handling excess capacity, if periodic computations 94 determine that the number of thermal batteries in the “in use” state 82 exceeds the demand, one or more actively discharging thermal battery with the highest damage value will transition to the “idle” state 84, with its valves 18 and 20 closed. If two thermal batteries have identical damage values, proximity to the points of use is considered, where the thermal battery closest to the points of use, e.g., thermal battery C, will remain in the “in use” state 82. If a debilitating fault, e.g., leakage, occurs, the thermal battery transitions to the “inoperable fault” state 86, rendering it inoperable until the fault is cleared and the system undergoes a shutdown and restart. Both valves 18 and 20 remain closed in this state. If communication with other thermal batteries or the master controller 78 is lost, the thermal battery transitions to the “communication failure” is state. It continues to serve heating demands and discharge heat until communication is restored, at which point it transitions back to the “idle” state 84.

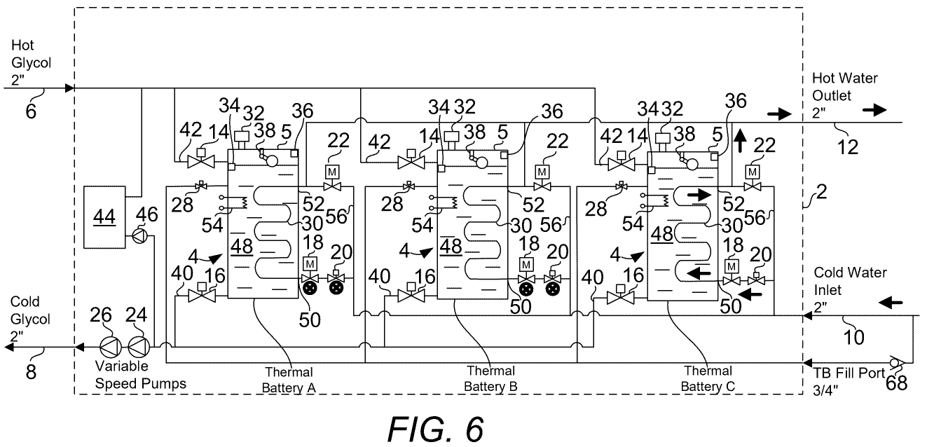

FIG. 6 illustrates an operational scenario of the heating system depicted in FIG. 1, utilizing the control scheme described in FIG. 5. In this scenario, the demand for hot water is met by a single thermal battery, specifically thermal battery C. This is achieved by opening valves 18 and 20 of thermal battery C, which places it in the “in-use” state 82, enabling domestic water to flow through its heat transfer fluid conductor 30. Thermal battery C is selected for operation because its SOC is sufficient to meet the current demand. For instance, it has an SOC greater than about 35%, allowing it to supply heat until its SOC decreases to a point where continued operation is no longer feasible, such as below about 25% and that there is already another thermal battery disposed in the “in-use” state 82. Alternatively, the operation may cease when the system determines no additional thermal batteries are needed to meet the current demand.

Although multiple thermal batteries 4 can work together to supply hot water, in certain cases, it is advantageous to preserve the stratification of the thermal batteries not currently in use. These batteries remain charged at higher SOC levels, ensuring optimal efficiency and readiness for future use. Periodic computations 94 determine the number of thermal batteries required to meet demand at full capacity, ensuring only the minimum number of batteries necessary are utilized. When a single thermal battery suffices to meet the demand, only the valves of that battery, e.g., valves 18 and 20 of thermal battery C, are opened. In this instance, thermal battery C is the only battery with a sufficiently high SOC, e.g., greater than about 35%, to remain in the “in-use” state 82. Furthermore, to distribute usage more equitably among the thermal batteries A, B, and C, preference is given to the battery with the least prior service or damage. This ensures balanced wear and extends the overall lifespan of the system components. The selected battery transitions from the “idle” state 84 to the “in-use” state 82 based on this principle.

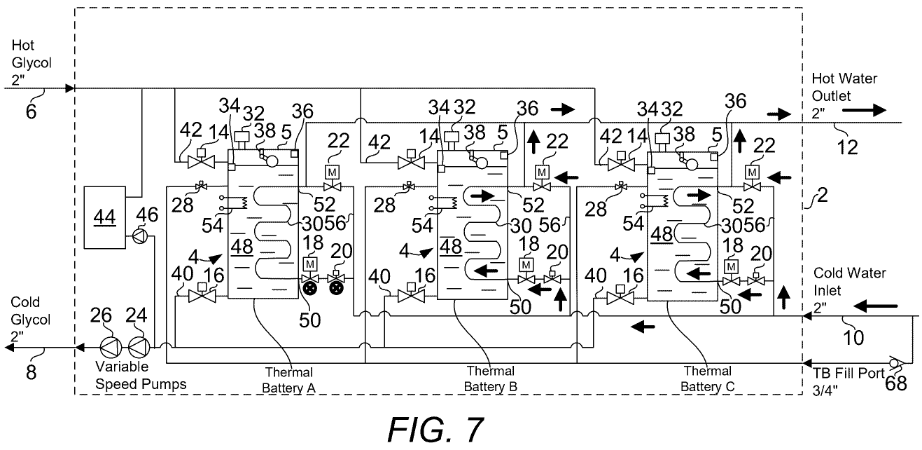

FIG. 7 illustrates an operational scenario of the heating system shown in FIG. 1, utilizing the control scheme described in FIG. 5. In this scenario, the demand for hot water is met by two thermal batteries 4, specifically thermal batteries B and C. Both thermal batteries are placed in the “in-use” state 82 by opening valves 18 and 20 of each, allowing domestic water to flow through the heat transfer fluid conductor 30 of both thermal batteries. The heating system determines that two thermal batteries are required to meet the current hot water demand. Thermal batteries B and C satisfy at least one of the two conditions necessary for transitioning to the “in-use” state 82, i.e., their SOC is greater than about 35% and their damage values are the lowest among all the thermal batteries in the heating system. By meeting these conditions, thermal batteries B and C are selected to ensure efficient operation and balanced usage of the thermal batteries.

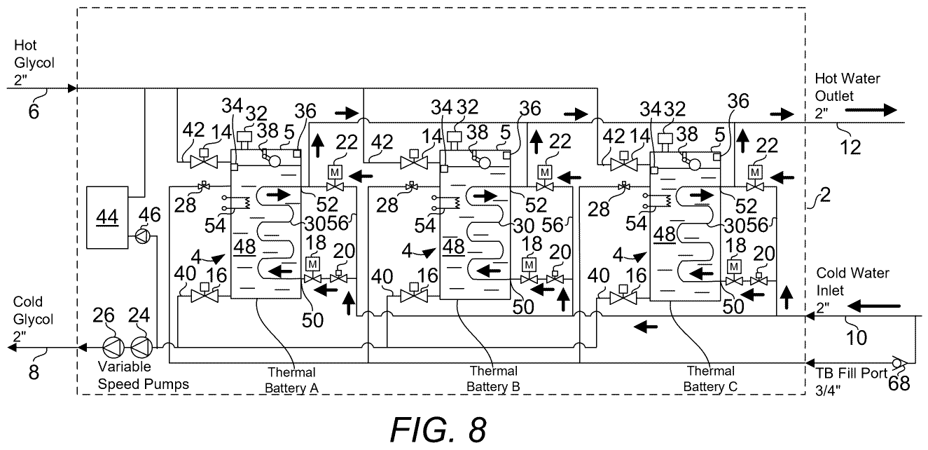

FIG. 8 illustrates an operational scenario of the heating system shown in FIG. 1, utilizing the control scheme described in FIG. 5. In this scenario, the demand for hot water is met by all three thermal batteries 4. Periodic computations 94 have determined that the total hot water demand can only be satisfied by opening valves 18 and 20 of all three thermal batteries in the heating system. Compared to the usage scenario depicted in FIG. 7, where only thermal batteries B and C were utilized, thermal battery A now also participates in meeting the total hot water demand. This ensures the system can deliver the required heating power efficiently.

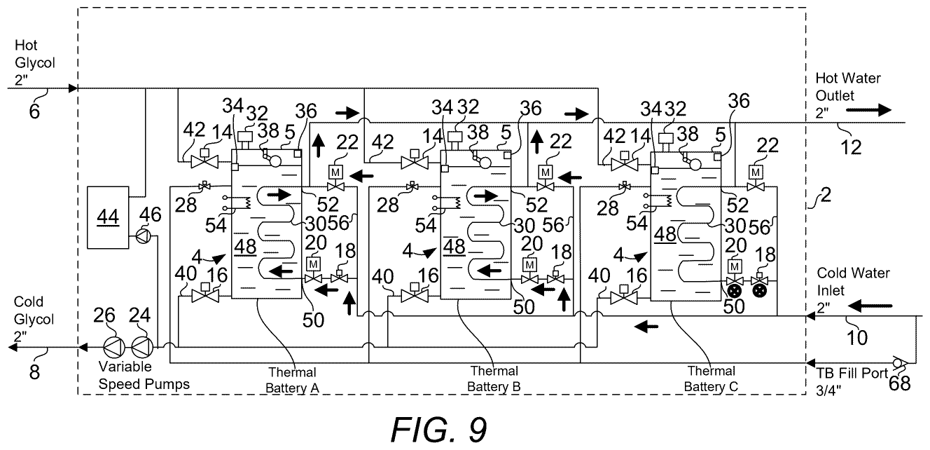

FIG. 9 illustrates an operational scenario of the heating system shown in FIG. 1, utilizing the control scheme described in FIG. 5. In this scenario, the demand for hot water is met by two thermal batteries 4. Compared to the scenario depicted in FIG. 8, it is notable that thermal battery C is now in a state where valves 18 and 20 are closed, preventing it from discharging. This change may occur due to the depletion of SOC and reduction in demand. The SOC of thermal battery C may have dropped below about 25%, causing it to transition to the “unavailable” state 88 as there is already at least another thermal battery already disposed in the “in-use” state 82. A drop in the total hot water demand may result in the number of thermal batteries currently in use exceeding the required number. In this case, thermal battery C, having the highest damage value among the batteries, transitions to the “idle” state 84 to preserve its longevity.

These factors reflect the system's dynamic adjustments to optimize thermal battery usage based on real-time conditions.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A method for controlling a heating system to meet a heating demand, the heating system comprising more than one thermal battery, each of the more than one thermal battery comprises a storage container for holding a thermal energy storage material, a heat exchange tubing having a first end and a second end within which a fluid is configured to be disposed from the first end to the second end to be heated by the thermal energy storage material, a control valve interposed on the first end of the heat exchange tubing and a controller functionally connected to the control valve, said method comprising, using the controller for:
(a) comparing a state of charge (SOC) of one of the more than one thermal battery to a low thermal storage threshold, wherein if said SOC is lower than said low thermal storage threshold, disposing the control valve of the one of the more than one thermal battery in a closed state; and
(b) comparing said SOC of one of the more than one thermal battery to a high thermal storage threshold, wherein if said SOC is greater than said high thermal storage threshold, disposing the control valve of the one of the more than one thermal battery in an open state.

2. The method of claim 1, wherein the control valve includes a first valve and a second valve, the first valve is a fail-close valve and the second valve is a proportional valve.

3. The method of claim 1, wherein said low thermal storage threshold is about 25%.

4. The method of claim 1, wherein said high thermal storage threshold is about 35%.

5. A method for controlling a heating system to meet a heating demand, the heating system comprising more than one thermal battery, each of the more than one thermal battery comprises a cumulative measure of usage, a storage container for holding a thermal energy storage material, a heat exchange tubing having a first end and a second end within which a fluid is configured to be disposed from the first end to the second end to be heated by the thermal energy storage material, a control valve interposed on the first end of the heat exchange tubing and a controller functionally connected to the control valve, said method comprising, using the controller for comparing a number of units of the more than one thermal battery required to meet the heating demand to a number of units of the more than one thermal battery having the control valve disposed in an open state,
wherein if said number of units of the more than one thermal battery required to meet the heating demand is lower than said number of units of the more than one thermal battery having the control valve disposed in an open state, disposing the control valve of the thermal battery having a highest cumulative measure of usage of the more than one thermal battery having the control valve disposed in an open state, in a closed state; and if said number of units of the more than one thermal battery required to meet the heating demand is higher than said number of units of the more than one thermal battery having the control valve disposed in an open state, disposing the control valve of the thermal battery having a lowest cumulative measure of usage of the more than one thermal battery having the control valve disposed in a closed state, in an open state.

6. The method of claim 5, wherein the control valve includes a first valve and a second valve, the first valve is a fail-close valve and the second valve is a proportional valve.

7. The method of claim 5, wherein said number of units of the more than one thermal battery required to meet the heating demand is determined by dividing the heating demand by the maximum thermal power afforded by one of the more than one thermal battery.

8. A method for controlling a heating system to meet a heating demand, the heating system comprising more than one thermal battery, each of the more than one thermal battery comprises a cumulative measure of usage, the more than one thermal battery comprises a storage container for holding a thermal energy storage material, a heat exchange tubing having a first end and a second end within which a fluid is configured to be disposed from the first end to the second end to be heated by the thermal energy storage material, a control valve interposed on the first end of the heat exchange tubing and a controller functionally connected to the control valve, said method comprising, using the controller for:
(a) comparing a state of charge (SOC) of one of the more than one thermal battery to a low thermal storage threshold, wherein if said SOC is lower than said low thermal storage threshold, disposing the control valve of the one of the more than one thermal battery in a closed state;
(b) comparing said SOC of one of the more than one thermal battery to a high thermal storage threshold, wherein if said SOC is greater than said high thermal storage threshold, disposing the control valve of the one of the more than one thermal battery in an open state; and
(c) comparing a number of units of the more than one thermal battery required to meet the heating demand to a number of units of the more than one thermal battery having the control valve disposed in an open state, wherein if said number of units of the more than one thermal battery required to meet the heating demand is lower than said number of units of the more than one thermal battery having the control valve disposed in an open state, disposing the control valve of the thermal battery having a highest cumulative measure of usage of the more than one thermal battery having the control valve disposed in an open state, in a closed state; and if said number of units of the more than one thermal battery required to meet the heating demand is higher than said number of units of the more than one thermal battery having the control valve disposed in an open state, disposing the control valve of the thermal battery having a lowest cumulative measure of usage of the more than one thermal battery having the control valve disposed in a closed state, in an open state.

9. The method of claim 8, wherein the control valve includes a first valve and a second valve, the first valve is a fail-close valve and the second valve is a proportional valve.

10. The method of claim 8, wherein said low thermal storage threshold is about 25%.

11. The method of claim 8, wherein said high thermal storage threshold is about 35%.

12. The method of claim 8, wherein said number of units of the more than one thermal battery required to meet the heating demand is determined by dividing the heating demand by the maximum thermal power afforded by one of the more than one thermal battery.
